(19) United States
(12) Patent Application Publication
(10) Pub. No.: US 2004/0128216 A1
(43) Pub. Date: Jul. 1, 2004

(54) System and method for managing accounts payable

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/648,747

(22) Filed: Aug. 25, 2003

(30) Foreign Application Priority Data
Dec. 27, 2002 (TW) 91137596

(51) Int. Cl. G06F 17/60

(52) U.S. Cl. 705/30

(57) ABSTRACT

A system and method for conducting accounting operations related to account payable according to procurement data and payment data obtained from external systems. The system includes a database server (3) for storing account payable data; an application server (2) electrically connected with the database server for accessing and processing data stored in the database server; and a plurality of client computers (1) electrically connected to the application server for downloading data from and uploading data to the database server. The application server can visit a procurement management system (5), an inventory management system (6) and a bank note management system (7) and access data therefrom via a communications network (4). Thus, the present invention can directly conduct accounting operations related to account payable according to obtained procurement data and payment data.

### BACKGROUND OF THE INVENTION

1. Field of the Invention

This invention relates to systems and methods for managing accounts payable, and more particularly to a system and method which can automatically conduct accounting operations related to accounts payable according to procurement data and payment data obtained from external systems.

2. Description of Related Art

The effective management of accounts payable is always an important subject of financial management of an enterprise. Nowadays, there are many computer system developed for managing accounts payable, mainly focusing on automatic booking and recording of accounting entries. Such computer systems make some improvements on reducing workload and human error. However, the efficient control of accounts payable is still problematic.

In addition, nowadays, computer systems for accounts payable management are generally connected with a financial management system, but are seldom directly connected with production or sales management systems. Manual work is required for integrating the production or sales data with financial data. Moreover, special events that occur in a purchase transaction, such as a purchase return or a purchase discount, cannot be automatically processed by a conventional financial management system.

P.R. China Pat. Publication No. CN1357849, published on Jul. 10, 2002, discloses a method for payment of accounts payable which allows users to select or set conditions for payment of accounts payable. However, the above method for payment of accounts payable involves rather too much human judgment. Moreover, the method does not provide direct dealing with data retrieved from external systems such as a procurement management system, an inventory management system and so on.

Accordingly, what is needed is a system and method which can overcome the above-mentioned problems.

### SUMMARY OF THE INVENTION

A primary object of the present invention is to provide a system which can automatically conduct accounting operations related to accounts payable according to procurement data and payment data obtained from external systems.

Another object of the present invention is to provide a method which can automatically conduct accounting operations related to accounts payable according to procurement data and payment data obtained from external systems.

In one aspect of the present invention, a system for managing accounts payable is provided. The system comprises a database server for storing accounts payable data; an application server electrically connected with the database server for accessing and processing data stored in the database server, the application server comprising a data obtaining module for obtaining data from external systems, a procurement data managing module for managing procurement data obtained from the external systems, a procurement confirming module for confirming fulfillment of procurements according to cargo receipt data, a purchase return managing module for managing purchase returns, a payment data managing module for managing payment data, a payment date and sum calculating module for calculating optimal payment sums and dates according to payment term data obtained by the data obtaining module, an account payable managing module for managing and updating the account payable data stored in the database server, and an account booking module for automatically generating accounting entries; and a plurality of client computers electrically connected to the application server for downloading data from and uploading data to the database server.

In another aspect of the present invention, a method for managing accounts payable is provided. The method comprises the steps of: (a) obtaining cargo receipt data of a procurement; (b) calculating an account payable for the procurement according to procurement data stored in a database server; (c) determining whether the procurement has an advance payment; (d) deducting a sum of the advance payment from the account payable if the procurement has an advance payment; (e) determining whether the procurement has a purchase discount; (f) deducting a sum of the purchase discount from the account payable if the procurement has a purchase discount; (g) determining whether a purchase return related to the procurement has occurred; (h) deducting a sum of a refund of the purchase return from the account payable if a purchase return related to the procurement has occurred; and (i) updating the account payable of the procurement.

In a further aspect of the present invention, another method for managing accounts payable is provided. The method comprises the steps of: (a) obtaining cargo receipt data of a procurement; (b) calculating one or more accounts payable of the procurement according to procurement data stored in a database server; (c) determining whether the procurement has an advance payment; (d) deducting a sum of the advance payment from the account payable if the procurement has an advance payment; (e) determining whether the procurement has a purchase discount; (f) deducting a sum of the purchase discount from the account payable if the procurement has a purchase discount; (g) determining whether a purchase return related to the procurement has occurred; (h) deducting a sum of a refund of the purchase return from the account payable if a purchase return has occurred; (i) updating the one or more accounts payable of the procurement; (j) retrieving payment terms data of the procurement according to the procurement data; (k) calculating an optimal payment sum and date according to the payment terms data; (1) sending the optimal payment sum and date to a financial department; (m) receiving a payment message about the procurement; and (n) balancing the one or more accounts payable of the procurement, and generating relevant accounting entries.

Other objects, advantages and novel features of the present invention will be drawn from the following detailed description of the present invention with attached drawings, in which:

### BRIEF DESCRIPTION OF THE DRAWINGS

FIG. 1 is a schematic diagram of hardware infrastructure of a system for managing accounts payable, according to a preferred embodiment of the present invention;

FIG. 2 is a block diagram showing main function modules of an application server of the system of FIG. 1;

FIG. 3 is a flowchart for automatically confirming an account payable of a procurement, in accordance with the present invention; and

FIG. 4 is a flowchart for balancing an account payable of a procurement, in accordance with the present invention.

### DETAILED DESCRIPTION OF THE INVENTION

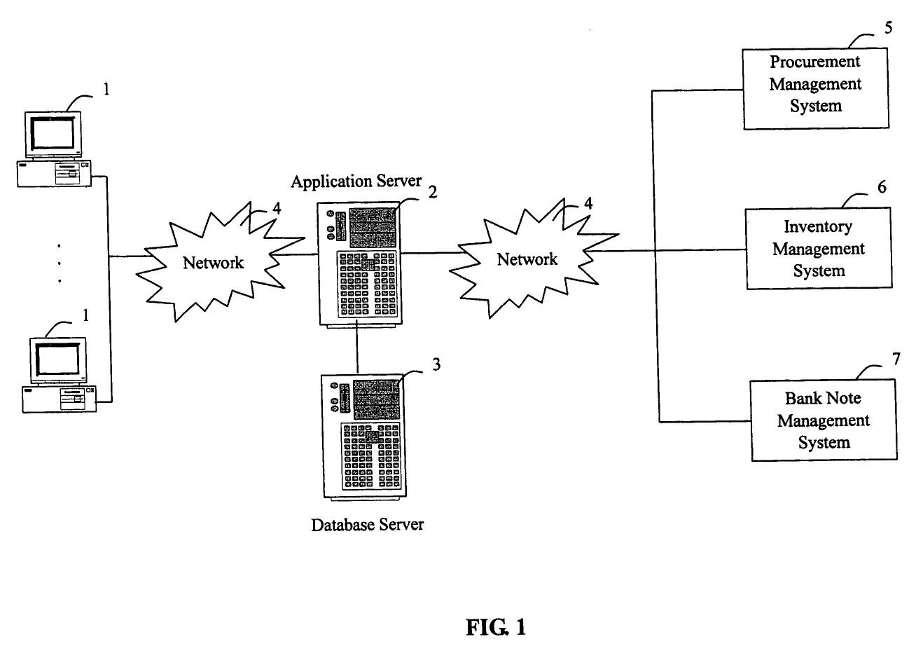

FIG. 1 is a schematic diagram of hardware infrastructure of a system for managing accounts payable, according to the preferred embodiment of the present invention. The hardware infrastructure comprises a database server 3, an application server 2, and a plurality of client computers 1. The database server 2 stores accounts payable data of an enterprise. The application server 2 can electronically visit a procurement management system 5, an inventory management system 6 and a bank note management system 7, and retrieve data therefrom via a communications network 4. The procurement management system 5 is used for managing and storing procurement data of the enterprise. The procurement data comprise procurement records, procurement sums, payment terms, accounts payable, and so on. The inventory management system is used for managing and storing current inventory data and cargo receipt records. Each client computer 1 can visit the application server 2 via the communications network 4, and further access data stored in the database server 3 via the application server 2. The communications network 4 can be the Internet or an intranet.

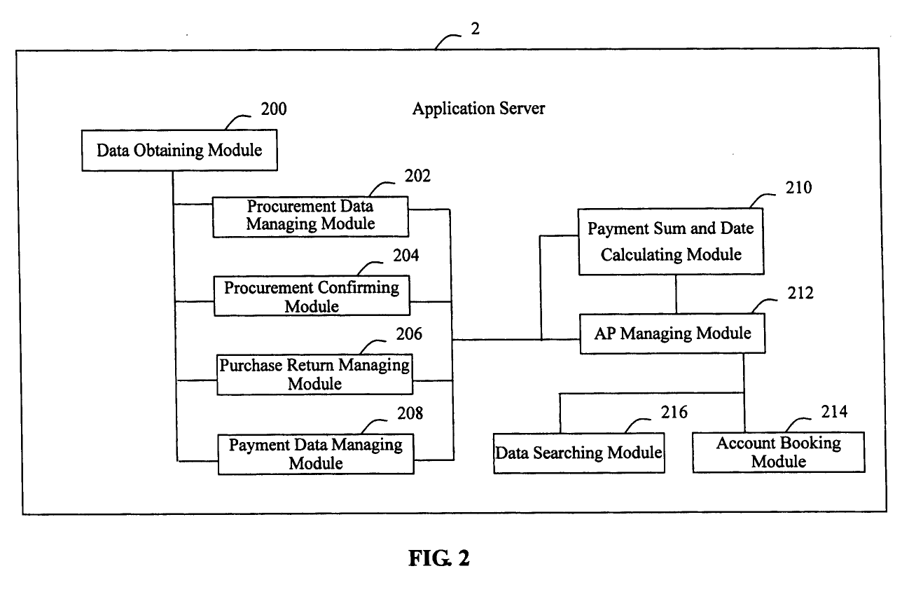

FIG. 2 is a block diagram showing main function modules of the application server 2. The application server 2 comprises a data obtaining module 200, a procurement data managing module 202, a procurement confirming module 204, a purchase return managing module 206, a payment data managing module 208, a payment date and sum calculating module 210, an accounts payable (AP) managing module 212, an account booking module 214, and a data searching module 216.

The data obtaining module 200 is for retrieving data from the sales management system 5, the inventory management system 6 and the bank note management system 7 via the communications network 4.

The procurement data managing module 202 is for managing procurement data obtained from the procurement management system 5, said data including suppliers, procurement sums, payment terms, accounts payable and so on.

The procurement confirming module 204 is for confirming fulfillment of a procurement according to a cargo receipt message related to the procurement sent from the inventory management system 6.

The purchase return managing module 206 is for managing purchase returns according to purchase return data obtained from the procurement management system 5.

The payment data managing module 208 is for managing payment data retrieved from the bank note management system 7, including advance payment data on procurements.

The payment date and sum calculating module 210 is used for calculating optimal payment dates and sums according to payment terms of procurements. Generally, an earlier payment date is provided with a purchase discount; for instance, a 3% discount for payment within 20 days of invoicing.

The AP managing module 212 is for managing accounts payable data stored in the database server 3. When a cargo receipt message released from the inventory management system 6 shows that a procurement is fulfilled, the account payable related to the procurement is confirmed, and the account payable data are updated in the database server 3. If a purchase return occurs or a purchase discount applies, the AP managing module 212 automatically updates account payable data in the database server 3.

The account booking module 214 is for automatically generating relevant accounting entries of sales transactions.

The data searching module 216 is provided for users to search accounts payable data and relevant accounting entries.

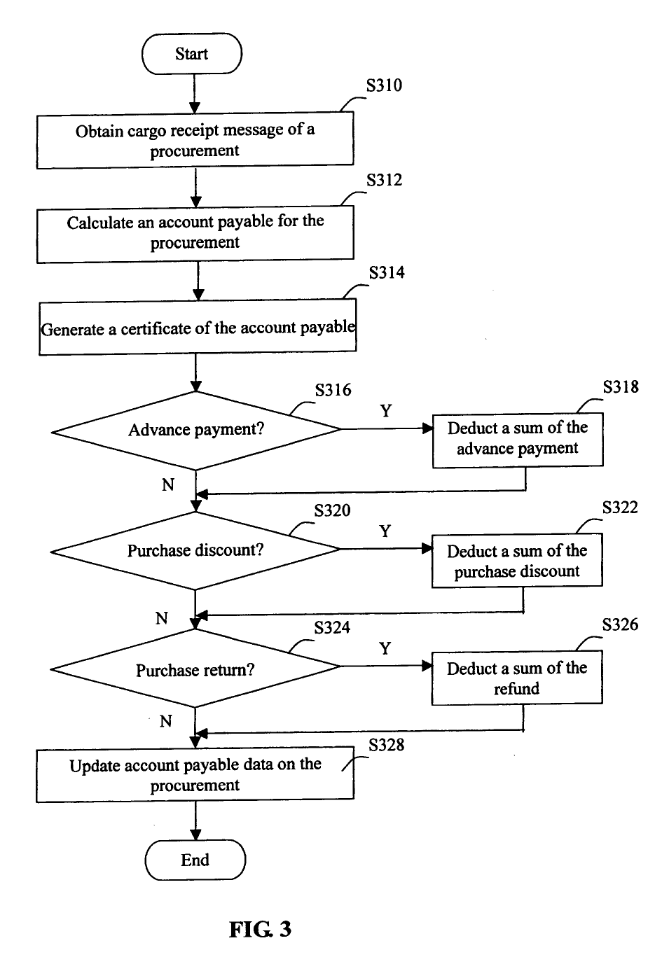

FIG. 3 is a flowchart for automatically confirming an account payable of a procurement, in accordance with the present invention. In step S310, the data obtaining module 200 obtains a cargo receipt message related to a procurement from the inventory management system 6, to confirm fulfillment of the procurement. In step S312, the AP managing module 212 calculates an account payable for the procurement. More than one account payable for the procurement may need to be calculated. However, for the sake of simplicity, it will be assumed hereafter that only one account payable is calculated. In step S314, the AP managing module 212 generates a certificate of the account payable related to the procurement, to confirm the account payable. In step S316, the payment data managing module 208 of the application server 2 determines whether the procurement has an advance payment. If the procurement has an advance payment, in step S318, the AP managing module 212 deducts a sum of the advance payment from the account payable of the procurement. If the procurement does not have an advance payment, or when the advance payment is deducted, in step S320, the procurement data managing module 202 of the application server 2 determines whether the procurement has a purchase discount. If the procurement has a purchase discount, in step S322, the AP managing module 212 deducts a sum of the purchase discount from the account payable. If the procurement does not have a purchase discount, or when the purchase discount is deducted, in step S324, the purchase return managing module 206 of the application server 2 determines whether a purchase return related to the procurement has occurred. If a purchase return has occurred, in step S326, the AP managing module 212 deducts a sum of a refund related to the purchase return. If no purchase return has occurred, or when the refund of the purchase return is deducted, in step S328, the AP managing module 212 updates account payable data on the procurement.

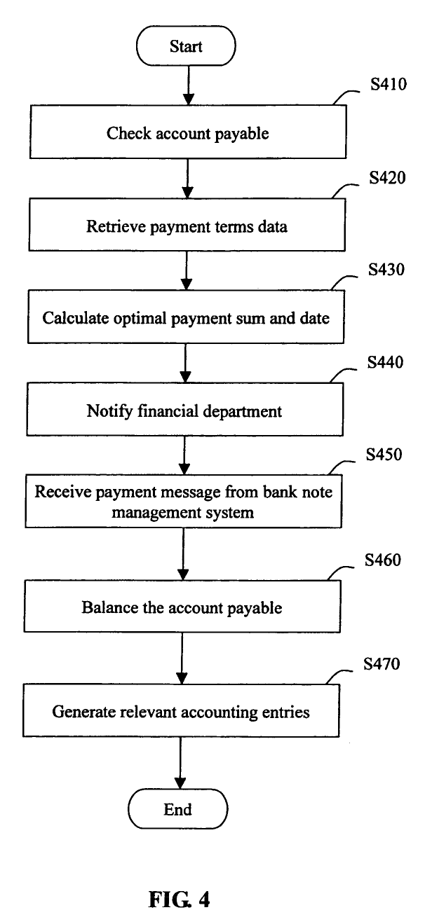

FIG. 4 is a flowchart for balancing an account payable of a procurement, in accordance with the present invention. In step S410, a relevant officer checks the account payable of the procurement to confirm correct details of the account payable. In step S420, the procurement data managing module 202 retrieves payment terms data on the procurement. In step S430, the payment date and sum calculating module 210 calculates an optimal payment sum and date according to the payment terms data. In the preferred embodiment of the present invention, the payment date and sum calculating module 210 calculates the optimal payment sum and date by comparing the discount rates recorded in the payment terms with current bank loan interest rates on the same terms. In step S440, the application server 2 notifies a financial department about the optimal payment sum and date. In step S450, the application server 2 receives a payment message from the bank note management system 7 to confirm payment of the procurement. In step S460, the AP managing module 212 balances the account payable of the procurement. In step S470, the account booking module 214 generates relevant accounting entries related to the above transaction.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for managing accounts payable, the system comprising:
a database server for storing accounts payable data;
an application server electrically connected with the database server for accessing and processing data stored in the database server, the application server comprising a data obtaining module for obtaining data from external systems, a procurement data managing module for managing procurement data obtained from the external systems, a procurement confirming module for confirming fulfillment of procurements according to cargo receipt data, a purchase return managing module for managing purchase returns, a payment data managing module for managing payment data, a payment date and sum calculating module for calculating optimal payment sums and dates according to payment term data obtained by the data obtaining module, an account payable managing module for managing and updating the account payable data stored in the database server, and an account booking module for automatically generating accounting entries; and
a plurality of client computers electrically connected to the application server for downloading data from and uploading data to the database server.

2. The system as claimed in claim 1, wherein the application server further comprises a data searching module for users to search the accounts payable data and accounting entries data.

3. The system as claimed in claim 1, wherein the application server electrically connects with a procurement management system for accessing procurement data stored in the procurement management system and updating the accounts payable data in the database server accordingly.

4. The system as claimed in claim 1, wherein the application server electrically connects with an inventory management system for accessing cargo receipt data stored in the inventory management system.

5. The system as claimed in claim 1, wherein the application server electrically connects with a bank note management system for accessing payment data stored in the bank note management system.

6. A method for managing accounts payable, the method comprising the steps of:
(a) obtaining cargo receipt data of a procurement;
(b) calculating at least an account payable for the procurement according to procurement data stored in a database server;
(c) determining whether the procurement has an advance payment;
(d) deducting a sum of the advance payment from the account payable if the procurement has an advance payment;
(e) determining whether the procurement has a purchase discount;
(f) deducting a sum of the purchase discount from the account payable if the procurement has a purchase discount;
(g) determining whether a purchase return related to the procurement has occurred;
(h) deducting a sum of a refund of the purchase return from the account payable if a purchase return related to the procurement has occurred; and
(i) updating the account payable of the procurement.

7. The method as claimed in claim 6, wherein the step (a) further comprises the step of generating a certificate of the account payable.

8. The method as claimed in claim 6, wherein the procurement data are obtained from a procurement management system.

9. The method as claimed in claim 6, further comprising the steps of:
(j) retrieving payment terms data of the procurement according to the procurement data;
(k) calculating an optimal payment sum and date according to the payment terms data;
(l) sending the optimal payment sum and date to a financial department;
(m) receiving a payment message about the procurement; and
(n) balancing the account payable of the procurement, and generating relevant accounting entries.

10. A system for managing accounts payable comprising:
a database server for storing accounts payable data;
means for retrieving cargo receipt data of a procurement;
means for calculating at least an account payable for the procurement according to the data of the procurement;
means for determining whether a related advance payment has been made and deducting a sum of said advance payment from the account payable if applicable;
means for determining whether a related purchase discount exists and deducting a sum of said purchase discount from the account payable if applicable;
means for determining whether a related purchase return has occurs and deducting a sum of said purchase return from the account payable if applicable; and
means for updating the account payable of the procurement.
